(19) United States
(12) Patent Application Publication
(10) Pub. No.: US 2011/0211787 A1
(43) Pub. Date: Sep. 1, 2011

(54) OPTICAL INTERCONNECT COMPONENTS

(76) Inventors: Huei Pei Kuo, Cupertion, CA (US); Michael Renne Ty Tan, Menlo Park, CA (US); Shih-Yuan Wang, Palo Alto, CA (US); Robert G. Walmsley, Palo Alto, CA (US); Paul Kessler Rosenberg, Sunnyvale, CA (US)

(21) Appl. No.: 13/127,020

(22) PCT Filed: Oct. 31, 2008
(86) PCT No.: PCT/US2008/082110

§ 371 Date: Apr. 29, 2011

(51) Int. Cl. G02B 6/26; G02B 6/28; G02B 6/255

(52) U.S. Cl. 385/24; 385/31; 427/163.2

(57) ABSTRACT

A component for an optical interconnect includes a waveguide having at least one surface that is configured at an angle equal to or less than 90° relative to an axis of the waveguide. A tap is operatively connected to the waveguide. The tap has an angled surface that is adhered to the angled surface of the waveguide. An angle of the angled surface of the tap is substantially identical to the angle of the angled surface of the waveguide. An axis of the tap is positioned at an angle that is two times the angle of the angled surface of the tap. An at least partially reflective coating established on at least a portion of the angled surface of the tap.

### BACKGROUND

The present disclosure relates generally to optical interconnect components.

Since the inception of microelectronics, a consistent trend has been toward the development of optoelectronic circuits, such as optical interconnects. This may be due, at least in part, to the fact that optoelectronic circuits may offer advantages over typical electronic circuits, such as, for example, a much larger bandwidth (by many orders of magnitude). Such optoelectronic circuits often involve the transmission of optical signals, and the interconversion of such optical signals into electronic signals. In some instances, performing optical signal transmission involves a waveguide. Optical waveguides are commonly made with glass or polymers. Extraction of a fraction of the guided signal with these solid waveguides typically requires complicated tapping structures. Some waveguides are hollow metal structures. Optical signals propagate in air through such structures, and as such, stringent alignment and collimation are required for proper signal transmission.

### BRIEF DESCRIPTION OF THE DRAWINGS

Features and advantages of embodiments of the present disclosure will become apparent by reference to the following detailed description and drawings, in which like reference numerals correspond to the same or similar, though perhaps not identical, components. For the sake of brevity, reference numerals having a previously described function may or may not be described in connection with subsequent drawings in which they appear.

FIGS. 1A through 1C together illustrate a schematic flow diagram for forming an embodiment of a component for an optical interconnect;

FIG. 2 is a schematic view of another embodiment of the component for the optical interconnect;

FIG. 3 is a schematic view of still another embodiment of the component for the optical interconnect;

FIG. 4 is a schematic view of an embodiment of an optical system;

FIG. 5 is a perspective semi-schematic view of an embodiment of an optical system including a plurality of components separated via cladding layers; and

FIG. 6 is a schematic view of another embodiment of the optical system including a total internal reflection mirror.

### DETAILED DESCRIPTION

Embodiments of the optical interconnect components disclosed herein include various waveguides which are configured to enable flexible topographical arrangements for the layout and routing of signal paths.

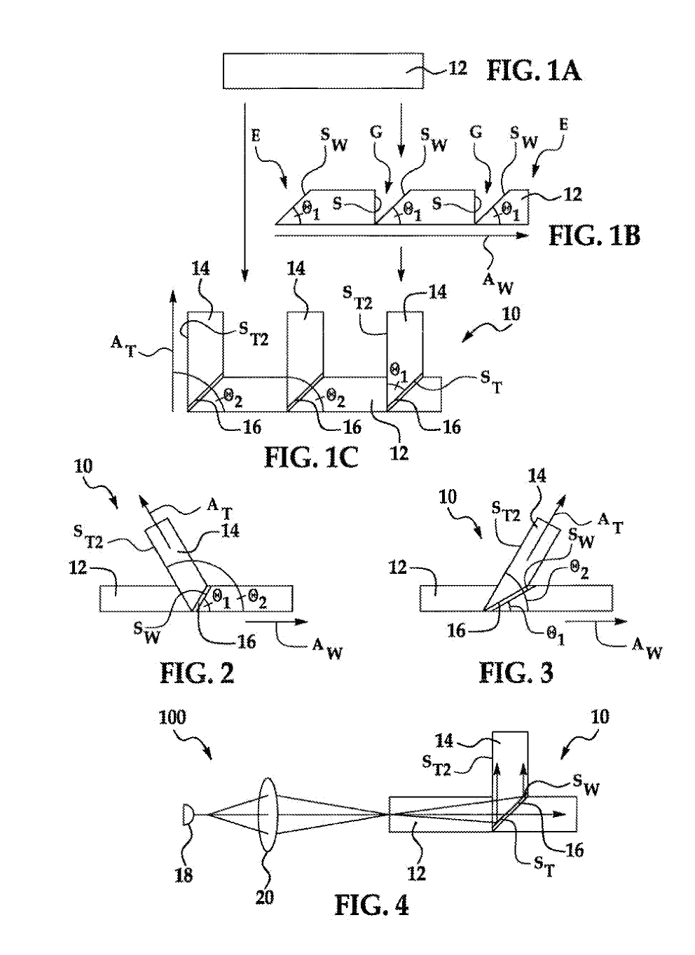

FIGS. 1A through 1C together depict various embodiments of the method for forming the optical interconnect component 10 (an embodiment of which is shown in FIG. 1C). Generally, one embodiment of the optical interconnect component 10 includes a waveguide 12 (shown in FIG. 1A) and at least one tap 14 (shown in FIG. 1C) operatively connected to, and in some instances, positioned in, the waveguide 12.

The waveguide 12 and tap 14 may be formed of any material that is capable of receiving and propagating light beams of a particular wavelength (ranging from 450 nm to 1.5 microns). As such, the desirable wavelength or range of wavelengths to be propagated may dictate the materials selected for the waveguide 12. It is to be understood that the waveguide 12 and tap 14 may be the same or different materials. In a non-limiting example, the waveguide 12 and/or tap 14 is formed of glass, polymeric material(s) (e.g., polycarbonate, polyamide, acrylics, etc.), silicon, or another like material. The waveguide(s) 12 and tap(s) 14 are generally in the form of a fiber, and thus are not hollow. In some instances, the waveguides 12 and taps 14 are in the form of a multi-mode fiber with a circular or rectangular cross-section. These types of fibers may consist of a core and a clad. The diameter of the core of each of the waveguide 12 and the tap 14 ranges from about 10 microns to about 1000 microns.

In some instances, the waveguide 12 and/or tap 14 is composed of holey or microstructured fibers. Such holey fibers have a substantially regular arrangement of air holes extending along the length of the fiber to act as a cladding layer. The core is generally formed by a solid region in the center of the substantially regular arrangement of air holes, or by an additional air hole in the center of the substantially regular arrangement of air holes. The effective refractive index of such fibers is determined by the density of the holes. As such, the holes may be arranged to change the effective index of the waveguide 12 and/or tap 14. The core of holey fibers will generally have a lower density of holes than the cladding layer, and thus, the effective index of the core is generally higher than that of the cladding.

In some instances, the waveguide 12 and tap 14 of the optical interconnect component 10 are made with the same core material and the same clad material. The desirable refractive index will depend, at least in part, on the wavelength or range of wavelengths of light to be transmitted through the component. In one non-limiting example, each of the waveguide(s) 12 and tap(s) 14 has a core with an index of refraction of about 1.51 and a cladding layer thereon with an index of refraction of about 1.49.

The component 10 shown in FIG. 1C may be formed via a variety of methods. As shown in FIG. 1B, one embodiment of the method includes forming one or more surfaces S_{W} in the waveguide 12. Generally, the number of surfaces S_{W} formed/exposed will depend, at least in part, on the desirable number of taps 14 to be included in the component 10.

The surface S_{W} is configured at an angle θ₁ that is equal to or less than 90° relative to the axis A. In a non-limiting example, θ₁ ranges from about 30° to about 60°. As shown in FIG. 1B, the surface S_{W} may be formed at an end E of the waveguide 12, or may be formed at any desirable position along the axis A_{W} of the waveguide 12. The positioning of the surface S_{W} generally depends, at least in part, on the desirable route(s) for the light beams transmitted through the component 10.

When it is desirable to form the surface S_{W} at an end E, the waveguide 12 is cut so that a desirable end E is tapered to the desirable angle. In one non-limiting example, the waveguide 12 is cut using a thermal molding or hot embossing process, similar in principle to processes used to fabricate vinyl records. Molding or embossing is relatively cost effective and reliable. In another non-limiting example, ultraviolet (UV) imprinting could also be used to cut the waveguide 12.

When it is desirable to form the surface S_{W} a spaced distance from the ends E, a gap G may be formed in the waveguide 12 to expose the angled waveguide surface S_{W}. In the example shown in FIG. 1B, the waveguide 12 with the cut-out is fabricated via one of the methods previously described. The fabricated waveguide 12 has the exposed surface S_{W} and the gap G. The positioning and configuration of the gap G generally depends, at least in part, on the desirable position and configuration for the tap 14 (as the gap G receives the tap 14, as shown in FIG. 1C). As shown in FIG. 1B, multiple gaps G may be formed in the waveguide 12. Such gaps G may be positioned at any desirable position along the axis A_{W} of the waveguide 12, and may be separated by predetermined distances. In some instances, the surfaces S_{W} adjacent to the various gaps G may be formed at the same angle θ₁ with respect to the axis A_{W} (as shown in FIG. 1B), and in other instances, the surfaces S_{W} adjacent to the various gaps G may have different angles θ₁ (not shown).

As previously mentioned, the gap G is adjacent to the surface S_{W}, but the gap G is also adjacent to at least one other surface S of the waveguide 12. The angle of this other surface S will depend, at least in part, on the angle θ₁ of the surface S_{W}. As will be discussed further hereinbelow, an axis A_{T} of the tap 14 is positioned at an angle θ₂ (relative to the axis A_{W} of the waveguide 12) that is two times the angle of the angled surface of the tap 14, which is substantially identical to the angle θ₁ of the waveguide angled surface S_{W}. As such, the angle (relative to the axis A_{W} of the waveguide 12) of the other surface S that is adjacent to the gap G is two times the angle θ₁ of the angled waveguide surface S_{W}. In the example shown in FIG. 1B, the angled waveguide surface S_{W} is at 45° with respect to axis A_{W}, and the surface S is at 90° with respect to axis A_{W}.

The fabrication of the optical component 10 also includes adhering tap(s) 14 to the exposed surface(s) S_{W}. The adhered tap(s) 14 are shown in FIG. 1C.

In the embodiments shown and discussed in the FIG. 1 series, the tap 14 includes an angled surface S_{T}, which is positioned at an angle that is substantially identical to the angle θ₁ of the waveguide angled surface S_{W}. By “substantially identical”, it is meant that the angles of the surfaces S_{W}, S_{T} are equal, or are less than a few degrees apart, so that the surfaces S_{W}, S_{T} may be adhered together without any substantial gap therebetween. As discussed further hereinbelow, the taps 14 may be adhered to the optical waveguides 12 with index matching adhesive(s). As such, any mismatch in the angles of the surfaces S_{W}, S_{T} is somewhat compensated for by filling such gaps with the adhesive. In some instances, it may be desirable that the angle of the surface S_{T} be slightly less than angle θ₁ of the surface S_{W} to allow for relatively easy insertion of the tap 14 into gap G of the waveguide 12.

The tap 14 also includes the axis A_{T} positioned at the angle θ₂ that is two times the angle of the angled surface S_{T}. In some instances, it is desirable that the reflected light beams be centered along the axis A_{T} of the tap 14. This is accomplished when the angle θ₂=2×θ₁. As shown in FIG. 1C, one other surface S_{T2} of the tap 14 is configured such that it is parallel to the axis A_{T}. This surface S_{T2} abuts the other surface S of the waveguide 12 when the tap 12 is operatively positioned in a gap G of the waveguide 12.

As shown in the embodiment which begins at FIG. 1A and proceeds directly to FIG. 1C, a gap G may not be formed in the waveguide 12 prior to adhering the tap 14 thereto. In this instance, the material of the tap(s) 14 is more rigid than the material of the waveguide 12, and the tap(s) 14 may be directly inserted into the waveguide 12. Forcing the tap 14 into the waveguide 12 causes some of the waveguide material to conform to the shape of the tap 14. This forms the surface S_{W}, which has an angle θ₁ that is substantially identical to the tap, angled surface S_{T}.

Prior to adhering the tap 14 to the waveguide 12, an at least partially reflective coating 16 is established on the angled surface S_{T} of the tap 14. The percentage of reflectivity and the pattern in which the partially reflective coating 16 is established depend, at least in part, on the desirable beam splitting properties at the interface between the surfaces S_{W}, S_{T}, at which the coating 16 is positioned. In some instances, the coating 16 is partially reflective (i.e., less than 100% reflective) and is established on the entire tap angled surface S_{T}. In other instances, the coating 16 is 100% reflective, and is established on portions of the tap angled surface S_{T} (e.g., in a dotted, striped or other like pattern). In still other instances, some portions of the coating 16 are 100% reflective, while other portions of the coating 16 are less than 100% reflective. Light beams impinging on the reflective portions of the coating 16 will be redirected into the tap 14, and light beams impinging on the less or non-reflective portions of the coating 16, or those areas of the tap angled surface S_{T} not including the coating 16 will continue to pass through the waveguide 12 (see, for example, FIG. 4).

Non-limiting examples of suitable materials for the partially reflective coating 16 include aluminum, silver or another material that is a reflector of the selected wavelength of light established at a thickness that is less than or equal to 0.01 microns. Non-limiting examples of suitable materials for the fully reflective coating 16 include aluminum, silver or another material that is a reflector of the selected wavelength of light established at a thickness that is greater than or equal to 1 micron. Such materials may be established via any suitable technique, including, but not limited to standard vacuum deposition techniques (e.g., thermal or e-beam evaporation, sputtering, etc.).

In either of the methods disclosed in FIGS. 1A through 1C, adherence of the tap 14 to the surface. S_{W} Is accomplished via an index matching adhesive material, such as index matching glue. Suitable index matching adhesives are commercially available from Norland Products, Inc. in Cranbury, N.J. The glue is selected to have an index of refraction that matches the waveguide 12 and the tap 14, and thus will minimize unintended reflection at the interface of waveguide 12 and tap 14. The index matching adhesive material may be established on the waveguide angled surface S_{W} (if exposed), the tap angled surface S_{T} (having the at least partially reflective coating 16 established thereon), or the other tap surface S_{T2}.

FIGS. 2 and 3 illustrate other examples of the component 10. In FIG. 2, the surface S_{W} is angled at 60° with respect to the axis A_{W}, and the other surface S_{T2} of the tap 14 is angled at 120°. In FIG. 3, the surface S_{W} is angled at 30° with respect to the axis A_{W}, and the other surface S_{T2} of the tap 14 is angled at 60°.

Referring now to FIG. 4, an embodiment of an optical system 100, including an embodiment of the component 10 is depicted. In addition to the component 10, the system 100 includes a light source 18 and a lens 20. The lens 20 is positioned between the light source 18 and the component 10. The light source 18 emits light beams of a desirable wavelength, and the lens 20 is configured to direct the light beams from the light source 18 into the waveguide 12. In a non-limiting example, the light source 18 is a vertical-cavity surface-emitting laser (VCSEL), and the lens 20 is a microlens with a focal length of about 0.3 mm.

While not shown in the Figures, one or more detectors may be positioned to detect some or all of the light beams exiting the optical components 10.

In one non-limiting example, when the waveguide 12 and tap 14 each has an index of refraction of about 1.5, and the waveguide 12 is about 30 cm long, it may be desirable to maintain the skew of clock pulses to <20 ps over the waveguide length. This may be accomplished when the maximum light beam external angle (i.e., outside the waveguide 12) is less than about 7°, and the maximum light beam internal angle (i.e., inside the waveguide 12) is less than about 5°. It is to be understood that the values in this example are approximate desirable values, and that they are dependent, at least in part, upon the index of refraction of the materials, the length of the waveguide 12, and the operating data rate.

As depicted in FIG. 4, the light beams that are directed into the waveguide 12 impinge on the adhered angled surfaces S_{W}, S_{T} and are either reflected into the tap 14 or are transmitted through the waveguide 12. If the light beam encounters a portion of the coating 16 that is 100% reflective, such light beam will be redirected into the tap 16.

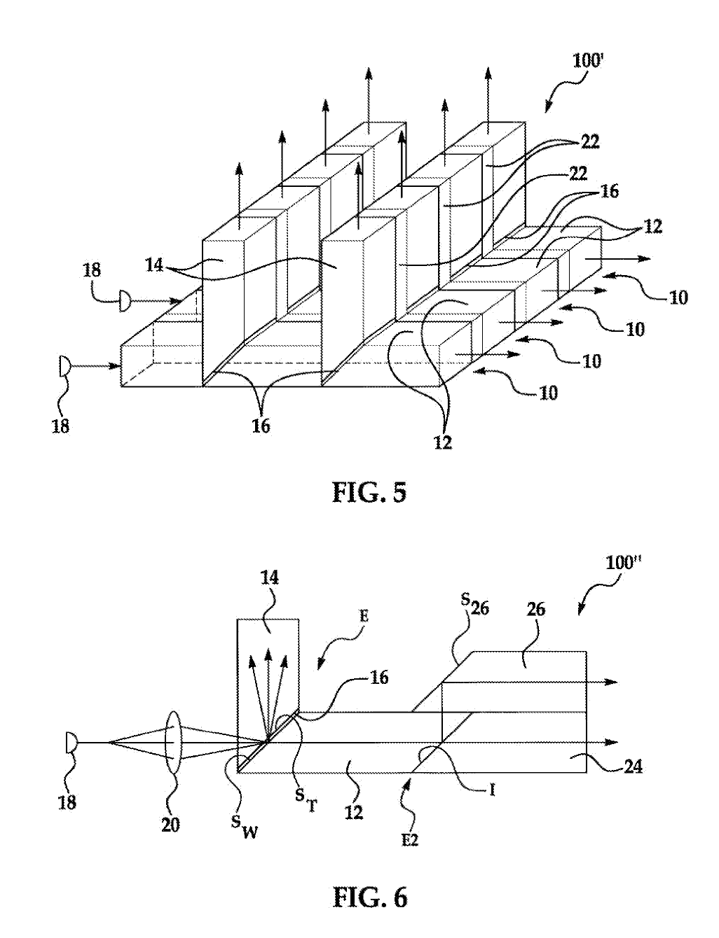

FIG. 5 depicts another embodiment of the optical system 100′ including a plurality of components 10 making up multiple parallel channels. Each component 10 or channel of the system 100′ is separated from an adjacent component 10 or channel via a cladding layer 22. The cladding layer 22 assists in reducing or eliminating optical crosstalk between the components 10. The cladding layer 22 is generally formed of a material having a lower refractive index than the refractive index of the waveguide 12 and the tap 14. Non-limiting examples of suitable cladding layer materials include fluorocarbon resins (such as TEFLON® from Dupont), silicon, insulating materials, or the like. The cladding layer 22 may be deposited via chemical vapor deposition (CVD), ion implementation of a dopant, dipping, or other like processes. The cladding materials may also be spun on, cured, and hardened when the temperature reaches the glass transition temperature.

While not shown, it is to be understood that each of the components 10 in the system 100′ has a light source 18 directing light beams to the respective waveguides 12. An individual lens 20 may also be utilized to direct the light beams from one light source 18 to the corresponding waveguide 12. The arrows shown in FIG. 5 illustrate how the light is guided through each of the components 10. As depicted, the light of the system 100′ is coupled in a parallel manner utilizing the components 10.

FIG. 6 depicts still another embodiment of the optical system 100″. In this embodiment, the tap 14 is adhered to an end E of the waveguide 12. As such, no gap G is formed in the waveguide 12.

The other end E2 of the waveguide 12 is operatively connected to a second waveguide 24 such that an interface I is formed therebetween. The surfaces of the waveguides 12, 24 at this interface I have the same angle with respect to the axis A_{W} of the waveguide 12. The interface I may have the at least partially reflective coating 16 established in a manner that achieves the desirable transmissivity and reflectivity of the light beams. In this instance, the waveguides 12, 24 may be formed of the same materials and have the same index of refraction. These surfaces may be adhered via an index matching glue.

This embodiment of the optical system 100″ includes a third waveguide 26 positioned such that any reflected light beams from the interface I are directed into the waveguide 26. As such, the position of the third waveguide 26 will depend, at least in part, on the configuration of the surfaces at the interface I. In one example, the waveguide 26 may be, stacked on the other waveguides 12, 24 such that a surface S₂₆ thereof receives the reflected light beams. This surface S₂₆ may be tapered at any desirable angle. In one instance, the angle of the surface S₂₆ may be configured so that total internal reflection occurs within this waveguide 26. As a non-limiting example, the waveguide 26 is formed of glass with an index of refraction of 1.5, and the medium adjacent the angled surface S₂₆ is air; as such, the surface S₂₆ may have an angle larger than 41.8° (e.g., 45°) and total internal reflection will occur. Instead of configuring the angle of the surface S₂₆ to achieve total internal reflection, it is to be understood that a reflective coating may be established on the surface S₂₆.

It is to be understood that a clad layer 22 (not shown in this Figure) may also be positioned between the third waveguide 26 and the waveguides 12, 24 upon which it is established. Such a clad layer does not interfere with the reflected light beams traveling from the interface I to the third waveguide 26.

Due to the flexibility in the materials used for the waveguides 12, 24, 26 and taps 14, a number of different light beam paths may be achieved. While straight waveguides 12, 24, 26 and taps 14 are shown in the figures, it is to be understood that the waveguides 12, 24, 26 and/or taps 14 may include bends and or curves. Furthermore, multiple components 10 may be configured in parallel to obtain a ribbon optical connector.

Clause 1: A component for an optical interconnect, comprising:

a waveguide having at least one surface that is configured at an angle equal to or less than 90° relative to an axis of the waveguide;

a tap operatively connected to the waveguide, the tap having an angled surface that is adhered to the angled surface of the waveguide, wherein an angle of the angled surface of the tap is, substantially identical to the angle of the angled surface of the waveguide, and an axis of the tap is positioned at an angle that is two times the angle of the angled surface of the tap; and

an at least partially reflective coating established on at least a portion of the angled surface of the tap.

Clause 2: The component as defined in clause 1 wherein the angled surface of the tap having the at least partially reflective coating established on the at least the portion is a beam splitter.

Clause 3: The component as defined in any of clauses 1 or 2 wherein the tap is operatively positioned in a gap formed in the waveguide.

Clause 4: The component, as defined in any of clauses 1 through 3 wherein the waveguide has an other surface configured at an angle equal to or less than 90° relative to the axis of the waveguide, and wherein the component further comprises:

an other tap operatively connected to the waveguide via an angled surface that is adhered to the other angled surface of the waveguide, wherein an angle of the angled surface of the other tap is substantially identical to the angle of the other surface of the waveguide, and an axis of the other tap is positioned at an angle that is two times the angle of the angled surface of the other tap; and

an other partially reflective coating established on at least a portion of the angled surface of the other tap.

Clause 5: The component as defined in clause 4 wherein the tap is operatively positioned iii a gap formed in the waveguide, wherein the other tap is operatively positioned in an other gap formed in the waveguide, wherein the gap and the other gap are positioned a predetermined distance from each other along a length of the waveguide, and wherein the axis of the tap is parallel to the axis of the other tap.

Clause 6: The component as defined in any of clauses 4 or 5 wherein the other tap includes a second angled surface configured to receive a light beam from the angled surface of the other tap and to redirect the received light beam about 90°.

Clause 7: The component as defined in any of clauses 1 through 6 wherein the at least partially reflective coating is less than 100% reflective and is established on the entire angled surface of the tap.

Clause 8: The component as defined in any of clauses 1 through 6 wherein the at least partially reflective coating is 100% reflective and is established on a portion of the angled surface of the tap.

Clause 9: The component as defined in any of clauses 1 through 8 wherein an end of the waveguide is configured at a 45° angle relative to the axis of the waveguide, and wherein the component further comprises:

a second waveguide having an end configured at a 45° angle that is operatively connected to the waveguide at the angled end; and

a third waveguide established on at least a portion of the waveguide and the second waveguide, the third waveguide including a 45° angled surface that is configured to redirect a light beam from an intersection at which the angled ends of the waveguide and the second waveguide meet and incident on the 45° angled surface about 90°.

Clause 10: A method of making the component as defined in any of clauses 1 through 8, the method comprising:

establishing the at least partially, reflective coating on the at least the portion of the angled surface of the tap;

cutting the waveguide, thereby forming the angled surface of the waveguide; and

adhering the angled surface of the tap to the angled surface of the waveguide.

Clause 11: The method as defined in clause 10 wherein the cutting the waveguide i) is accomplished by inserting the tap into the waveguide or ii) includes forming a gap in the waveguide that is configured to receive the tap.

Clause 12: The method as defined in any of clauses 10 or 11 wherein prior to adhering, the method further comprises establishing an index matching adhesive material on the angled surface of the tap, the angled surface of the waveguide, or a surface of the tap that is parallel to the axis of the tap.

Clause 13: An optical system, comprising:

a light source; and

an optical component configured to have light beams input therein from the light source, the optical component including:
a waveguide having at least one surface that is configured at an angle equal to or less than 90° relative to an axis of the waveguide;
a tap operatively connected to the waveguide, the tap having an angled surface that is adhered to the angled surface of the waveguide, wherein an angle of the angled surface of the tap is substantially identical to the angle of the angled surface of the waveguide, and an axis of the tap is positioned at an angle that is two times the angle of the angled surface of the tap; and
an at least partially reflective coating established on at least a portion of the angled surface of the tap.

Clause 14: The optical system as defined in clause 13, further comprising a lens positioned between the light source and the optical component, the lens configured to direct the light beams from the light source into the waveguide of the optical component.

Clause 15: The optical system as defined in any of clauses 13 or 14 wherein the waveguide has an other surface configured at an angle equal to or less than 90° relative to the axis of the waveguide, and wherein the component further comprises:

an other tap operatively connected to the waveguide via an angled surface that is adhered to the other angled surface of the waveguide, wherein an angle of the angled surface of the other tap is substantially identical to the angle of the other surface of the waveguide, and an axis of the other tap is positioned at an angle that is two times the angle of the angled surface of the other tap; and

an other partially reflective coating established on at least a portion of the angled surface of the other tap.

Clause 16: The optical system as defined in any of clauses 13 through 15, further comprising:

a plurality of other light sources;

a plurality of other optical components, each one of the other optical components configured to have light beams input therein from one of the plurality of other light sources, each of the other optical components including:
a waveguide having at least one surface that is configured at an angle equal to or less than 90° relative to an axis of the waveguide;
a tap operatively connected to the waveguide, the tap having an angled surface that is adhered to the angled surface of the waveguide, wherein an angle of the angled surface of the tap is substantially identical to the angle of the angled surface of the waveguide, and an axis of the tap is positioned at an angle that is two times the angle of the angled surface of the tap; and
an at least partially reflective coating established on at least a portion of the angled surface of the tap; and

a cladding layer separating each optical component from an adjacent optical component, the cladding layer having an index of refraction that is lower than an index of refraction, of the waveguides and the taps of each of the plurality of other optical components.

Clause 17: The optical system as defined in clause 16, further comprising a plurality of lenses, each of the plurality of lenses positioned between one of the light sources and one of the optical components, each of the lenses configured to direct the light beams from the one of the light sources into the waveguide of the corresponding one of the optical components.

While several embodiments have been described in detail, it will be apparent to those skilled in the art that the disclosed embodiments may be modified. Therefore, the foregoing description is to be considered exemplary rather than limiting.

What is claimed is:

1. A component for an optical interconnect, comprising:
a waveguide having at least one surface that is configured at an angle equal to or less than 90° relative to an axis of the waveguide;
a tap operatively connected to the waveguide, the tap having an angled surface that is adhered to the angled surface of the waveguide, wherein an angle of the angled surface of the tap is substantially identical to the angle of the angled surface of the waveguide, and an axis of the tap is positioned at an angle that is two times the angle of the angled surface of the tap; and
an at least partially reflective coating established on at least a portion of the angled surface of the tap.

2. The component as defined in claim 1 wherein the angled surface of the tap having the at least partially reflective coating established on the at least the portion is a beam splitter.

3. The component as defined in claim 1 wherein the tap is operatively positioned in a gap formed in the waveguide.

4. The component as defined in claim 1 wherein the waveguide has an other surface configured at an angle equal to or less than 90° relative to the axis of the waveguide, and wherein the component further comprises:
an other tap operatively connected to the waveguide via an angled surface that is adhered to the other angled surface of the waveguide, wherein an angle of the angled surface of the other tap is substantially identical to the angle of the other surface of the waveguide, and an axis of the other tap is positioned at an angle that is two times the angle of the angled surface of the other tap; and
an other partially reflective coating established on at least a portion of the angled surface of the other tap.

5. The component as defined in claim 4 wherein the tap is operatively positioned in a gap formed in the waveguide, wherein the other tap is operatively positioned in an other gap formed in the waveguide, wherein the gap and the other gap are positioned a predetermined distance from each other along a length of the waveguide, and wherein the axis of the tap is parallel to the axis of the other tap.

6. The component as defined in claim 4 wherein the other tap includes a second angled surface configured to receive a light beam from the angled surface of the other tap and to redirect the received light beam about 90°.

7. The component as defined in claim 1 wherein the at least partially reflective coating is less than 100% reflective and is established on the entire angled surface of the tap.

8. The component as defined in claim 1 wherein the at least partially reflective coating is 100% reflective and is established on a portion of the angled surface of the tap.

9. The component as defined in claim 1 wherein an end of the waveguide is configured at a 45° angle relative to the axis of the waveguide, and wherein the component further comprises:
a second waveguide having an end configured at a 45° angle that is operatively connected to the waveguide at the angled end; and
a third waveguide established on at least a portion of the waveguide and the second waveguide, the third waveguide including a 45° angled surface that is configured to redirect a light beam from an intersection at which the angled ends of the waveguide and the second waveguide meet and incident on the 45° angled surface about 90°.

10. A method of making the component as defined in claim 1, the method comprising:
establishing the at least partially reflective coating on the at least the portion of the angled surface of the tap;
cutting the waveguide, thereby forming the angled surface of the waveguide; and
adhering the angled surface of the tap to the angled surface of the waveguide.

11. The method as defined in claim 10 wherein the cutting the waveguide i) is accomplished by inserting the tap into the waveguide or ii) includes forming a gap in the waveguide that is configured to receive the tap.

12. The method as defined in claim 10 wherein prior to adhering, the method further comprises establishing an index matching adhesive material on the angled surface of the tap, the angled surface of the waveguide, or a surface of the tap that is parallel to the axis of the tap.

13. An optical system, comprising:
a light source; and
an optical component configured to have light beams input therein from the light source, the optical component including:
a waveguide having at least one surface that is configured at an angle equal to or less than 90° relative to an axis of the waveguide;
a tap operatively connected to the waveguide, the tap having an angled surface that is adhered to the angled surface of the waveguide, wherein an angle of the angled surface of the tap is substantially identical to the angle of the angled surface of the waveguide, and an axis of the tap is positioned at an angle that is two times the angle of the angled surface of the tap; and
an at least partially reflective coating established on at least a portion of the angled surface of the tap.

14. The optical system as defined in claim 13 wherein the waveguide has an other surface configured at an angle equal to or less than 90° relative to the axis of the waveguide, and wherein the component further comprises:
an other tap operatively connected to the waveguide via an angled surface that is adhered to the other angled surface of the waveguide, wherein an angle of the angled surface of the other tap is substantially identical to the angle of the other surface of the waveguide, and an axis of the other tap is positioned at an angle that is two times the angle of the angled surface of the other tap; and
an other partially reflective coating established on at least a portion of the angled surface of the other tap.

15. The optical system as defined in claim 13, further comprising:
a plurality of other light sources;
a plurality of other optical components, each one of the plurality of other optical components configured to have light beams input therein from one of the plurality of other light sources, each of the other optical components including:
a waveguide having at least one surface that is configured at an angle equal to or less than 90° relative to an axis of the waveguide;
a tap operatively connected to the waveguide, the tap having an angled surface that is adhered to the angled surface of the waveguide, wherein an angle of the angled surface of the tap is substantially identical to the angle of the angled surface of the waveguide, and an axis of the tap is positioned at an angle that is two times the angle of the angled surface of the tap; and
an at least partially reflective coating established on at least a portion of the angled surface of the tap; and
a cladding layer separating each optical component from an adjacent optical component, the cladding layer having an index of refraction that is lower than an index of refraction of the waveguides and the taps of each of the plurality of optical components.
